(19) United States
(12) Patent Application Publication
(10) Pub. No.: US 2004/0221117 A1
(43) Pub. Date: Nov. 4, 2004

(54) Logic and method for reading data from cache

(76) Inventor: Charles F. Shelor, Arlington, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/429,009

(22) Filed: May 2, 2003

(51) Int. Cl. G06F 12/14

(52) U.S. Cl. 711/163

(57) ABSTRACT

A cache having an internal data memory is provided. The cache includes latching logic coupled to an output of the data memory and configured to latch data output from the data memory. The latch also includes determining logic responsive to a request for data, the determining logic configured to determine whether requested data currently resides in the latching logic. Finally, the latch includes inhibit logic configured to inhibit active operation of the data memory, in response to the determining logic, if it is determined that the requested data currently resides in the latching logic. A related method for reading data from a cache is also provided.

### FIELD OF THE INVENTION

The present invention generally relates to cache memories, and more particularly to a method and logic for reading data from a cache memory.

### BACKGROUND

A driving force behind computer-system innovation (or other processor-based systems) has been the demand for faster and more powerful processing capability. A major bottleneck in computer speed has historically been the speed with which data can be accessed from memory, referred to as the memory access time. The microprocessor, with its relatively fast processor cycle times, has frequently been delayed by the use of wait states during memory accesses to account for the relatively slow memory access times. Therefore, improvement in memory access times has been one of the major areas of research in enhancing computer performance.

In order to bridge the gap between fast-processor cycle times and slow-memory access times, cache memory was developed. As is known, a cache memory is a small amount of very fast, and relatively expensive, zero wait-state memory that is used to store a copy of frequently accessed code and data from main memory. A processor can operate out of this very fast memory and thereby reduce the number of wait states that must be interposed during memory accesses. When the processor requests data from memory and the data resides in the cache, then a cache read hit takes place, and the data from the memory access can be returned to the processor from the cache without incurring wait states. If the data is not in the cache, then a cache read miss occurs. In a cache read miss, the memory request is forwarded to the system, and the data is retrieved from main memory, as would normally be done if the cache did not exist. On a cache miss, the data that is retrieved from memory is provided to the processor and is also written into the cache due to the statistical likelihood that this data will be requested again by the processor.

An efficient cache yields a high “hit rate,” which is the percentage of cache hits that occur during all memory accesses. When a cache has a high hit rate, the majority of memory accesses are serviced with zero wait states. The net effect of a high cache hit rate is that the wait states incurred on a relatively infrequent miss are averaged over a large number of zero wait state cache hit accesses, resulting in an average of nearly zero wait states per access.

As is known, there are a wide variety of cache structures, and these structures typically vary depending on the application for the cache. Generally, however, the internal memory structure of a cache defines a data area and a tag area. Addresses of data stored in the cache are logged in the tag memory area of the cache. Typically, multiple bytes or words of sequential data are stored in a single cache line in the data memory area of the cache. A single address, or tag, is correspondingly stored in the associated tag memory area of the cache. When a request is made, via processor or other device, for data, the address (physical or virtual) is input to the cache and compared against the addresses currently stored in the tag memory area. As mentioned above, if the currently sought address resides within the tag memory, then a “hit” occurs and the corresponding data is retrieved from the data memory.

With the foregoing by way of introduction, reference is now made to FIG. 1, which is a block diagram illustrating certain components within a conventional cache memory 10. As mentioned above, a cache is a high-speed memory, that speeds accesses to main memory, particularly when well designed to have a high “hit” rate. As is known, an address bus 20 is input to the cache. If valid data corresponding to the value carried on address line 20 is stored within the cache, then that data is output on the cache output 38. The address bus 20 is coupled to the data memory 12, and the least significant bits of the address bus are used to access data stored within the data memory area 12. When data is written into the data memory of a cache, the most significant bits of the address bus are written into a corresponding location (i.e., a location corresponding to the least significant bits used for accessing and storing the data) in a tag memory 14 of the cache.

Data read from the data memory area 12 is held in a latch 13 or other circuit component until another read operation is performed from the data memory area 12 (at which time the data In the latch is overwritten). Likewise, address information retrieved from the tag memory portion 14 of the cache 10 is held in a latch 15 or other appropriate circuit component, until a subsequent retrieval of tag information is made from the tag memory area 14. Comparison logic 35 provides a comparison of the information retrieved from the tag memory 14 with the current address placed on address bus 20. If the comparison indicates that currently-requested data is located within the tag memory 14, then an output 36 of the comparison logic 35 may be directed to logic 40 for generating a read strobe 42 of the data memory 12. This logic 40 has been denoted in FIG. 1 as “conventional RS logic.” A register or other circuit component 50 may be provided for holding the data output from the latch 13. It should be appreciated that the latch 13 may be a separate circuit component or integrated as part of the data memory 12, depending upon the particular design of the data memory 12 of the cache 10.

During operation, the various circuit and logic elements within the cache 10 are all in a substantially constant state of operation. As is known, battery-operated, processor-driven portable electronic devices (e.g., personal digital assistants, cell phones, MP3 players, etc.) continue to proliferate. There is a corresponding desire to lower the power consumption of these devices, so as to extend the battery life of the batteries that power the devices. As cache sizes increase, the amount of power required to operate the cache also increases. Therefore, there is a desire to improve the structure and operation of cache memories to realize lower-power operation.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the advantages and novel features, the present invention is generally directed to a novel cache architecture and method for caching, which achieves a substantially reduced power-consumption level. In one embodiment, a cache comprises a data memory and logic configured to inhibit the data memory from retrieving requested data, if the requested data was previously read from the data memory and is currently available for retrieval from another circuit component within the cache.

In another embodiment, a method is provided for reading requested data from a cache memory. The method, in response to a first request for data, retrieves from a data memory more words of data than requested by the first request and temporarily holding the retrieved data in a circuit component. Then, in response to a second, subsequent request for data, the method inhibits active operation of the data memory and retrieves the requested data from the circuit component.

### DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a block diagram illustrating certain internal components of a conventional cache memory 10.

FIG. 2 is a block diagram illustrating certain circuit components of a cache memory, similar to that illustrated in FIG. 1, to highlight certain elements of one embodiment of the invention.

FIG. 3 is a schematic diagram illustrating logic for generating a read strobe of a data memory in accordance with one embodiment of the invention.

FIG. 4 is a block diagram similar to FIG. 2, illustrating an alternative embodiment of the present invention.

FIG. 5 is a flowchart illustrating the top-level functional operation of the method constructed in accordance with one embodiment of the present invention.

FIG. 6 is a flowchart illustrating the top-level functional operation of a method constructed in accordance with an alternative embodiment of the present invention.

FIG. 7 is a flowchart illustrating the top-level functional operation of a method constructed in accordance with another embodiment of the present invention.

### DETAILED DESCRIPTION

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

It will be appreciated by persons skilled in the art that the cache memory and method for retrieving data described herein is not limited to the specific embodiments illustrated and described herein. Further, it will be appreciated by persons skilled in the art that the invention described in connection with the various embodiments herein is applicable to a wide variety of cache architectures and organizations. As one example, the invention has been illustrated herein in connection with a rather generic cache architecture. It will be appreciated that the invention is readily applicable to cache memories having separate data and instruction caches, as well as unified caches. Likewise, the concepts of the present invention are equally applicable to synchronous as well as asynchronous cache architectures. Further still, the concepts and teachings of the present invention are applicable to caches having a direct-mapped architecture, a fully-associative architecture, or a set-associative architecture. Further still, as is known by persons skilled in the art, and described in co-pending application Ser. No. ______ (TKHR Docket 252207-1020), filed on Apr. 3, 2003, the memory areas (both data and tag) are often partitioned into smaller cache blocks for simplicity and ease of implementation. The concepts and teachings of the present invention, as described herein, are completely applicable to cache architectures of this type. In such an architecture, the inventive concepts may be applied to each data memory area of each cache block. Other extensions and applications of the present invention will be readily apparent to those skilled in the art from the discussion provided herein below.

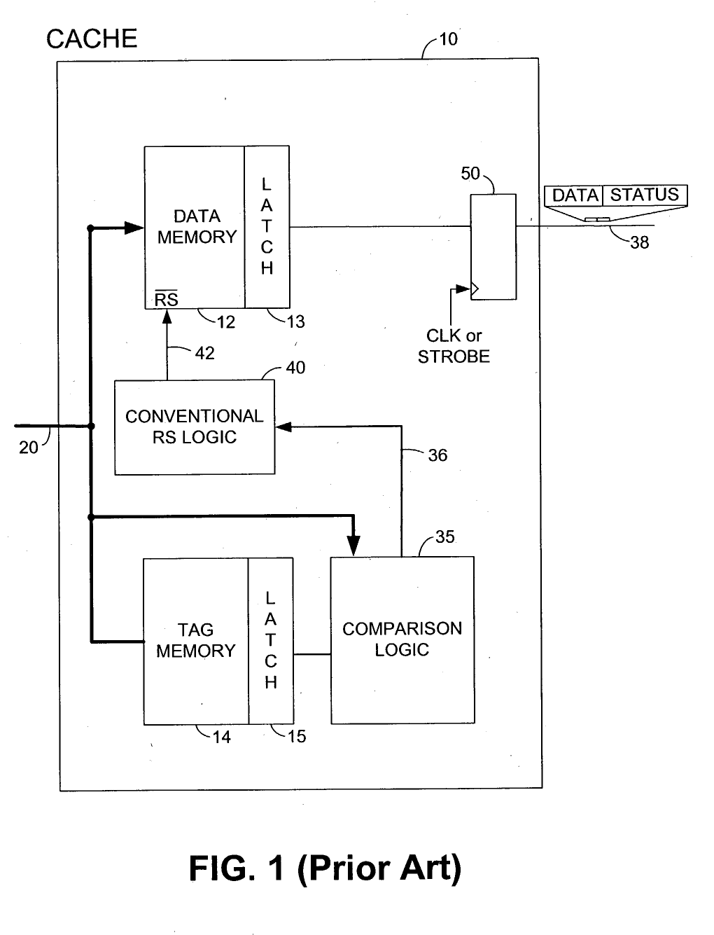

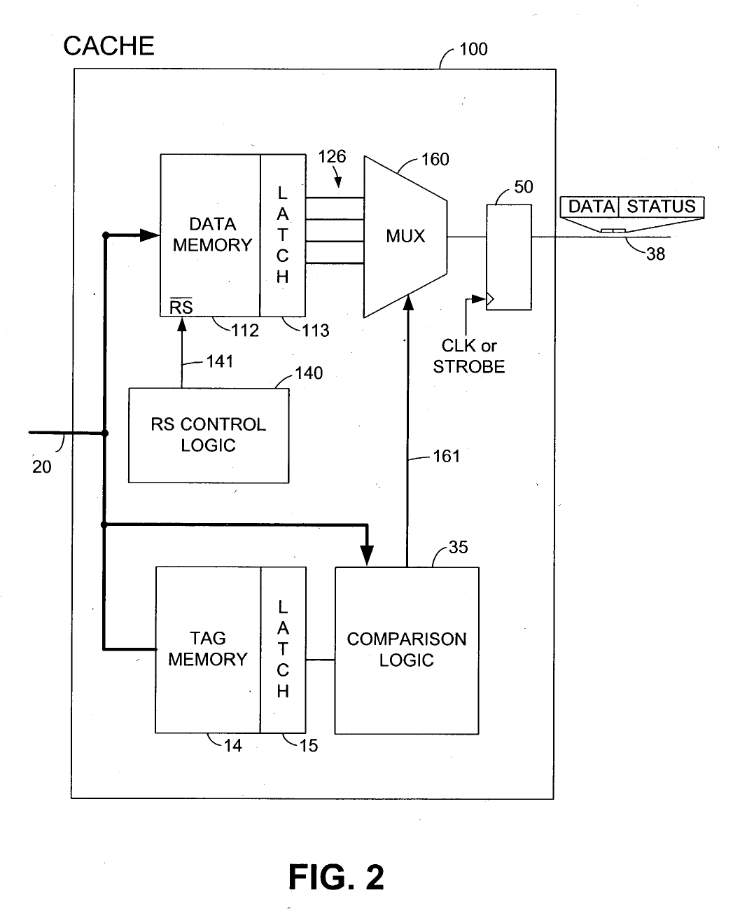

Reference is now made to FIG. 2, which is a block diagram illustrating portions of the internal architecture of a cache memory 100 constructed in accordance with one embodiment of the present invention. Before describing the details of this diagram, or other embodiments, it is noted that the diagrams provided herein are not intended to be limiting upon the scope or spirit of the present invention. Indeed, the embodiments illustrated herein, including the embodiment of FIG. 2, have been selected for illustration and more ready comparison to the prior art illustrated in FIG. 1. Further, the internal structure and operation of the various logic blocks illustrated in FIG. 2, beyond that illustrated or described herein, are known and readily implementable by persons skilled in the art. Consequently, the internal architecture and operation of these components need not be described herein.

Turning now to the diagram of FIG. 2, a cache memory 100 is illustrated having a data memory 112 and a tag memory 14. To facilitate the ready identification of certain inventive aspects of the embodiment of FIG. 2, like reference numerals have been used to designate components within the cache memory 100 that may be identical to components of the conventional cache memory 10 of FIG. 1. In this regard, what is different with regard to FIG. 2 is the read strobe control logic 140. The latch 113, and the addition of multiplexer 160 are also added in the embodiment of FIG. 2. As summarized above, the present invention takes advantage of the fact that a significant number of memory accesses are sequential. Taking advantage of this known property, accesses to the data memory 112 may be reduced, thereby reducing the power used by the data memory 112 and likewise the power consumed by the cache 100.

In the embodiment illustrated in FIG. 2, the latch component 113 may be designed to contain multiple words of data read from the data memory 112. Desirable sizes for the latch 113 may be two words, four words, or eight words. In one application, the data memory area 112 of the cache 100 contains cache lines that are eight data words each. Therefore, the latch 113 in such an embodiment is preferably eight data words or less. Further still, for design ease and implementation, the latch may be sized to be a power of two, such that it accommodates two data words, four data words, or eight data words. An output is provided for each data word of the latch 113. There are four such outputs 126 illustrated in the embodiment of FIG. 2. It should be appreciated that each of these illustrated outputs 126 may be thirty-two bits, or one data word, in width. These outputs may be directed to a multiplexer 160, or other appropriate circuit component, for selection to be delivered to the output 38 of the cache 100. That is, the multiplexer select lines 161 may be controlled to selectively route the desired output 126 from the latch 113 through the multiplexer 160 to the output 38.

A novel component to the embodiment of FIG. 2 is the read strobe control logic 140. This logic 140 is desired to operate to inhibit the normal strobing of the read strobe signal 141, when it is determined that the desired data already resides in the latch element 113. By inhibiting the normal strobing and reading of data from the data memory, switching of the various gate elements within the data memory 112 is inhibited, which significantly reduces the power consumption thereof (particularly when fabricated from CMOS). Accordingly, one aspect of this embodiment of the present invention is the generation of the read strobe signal 141 for the data memory 112.

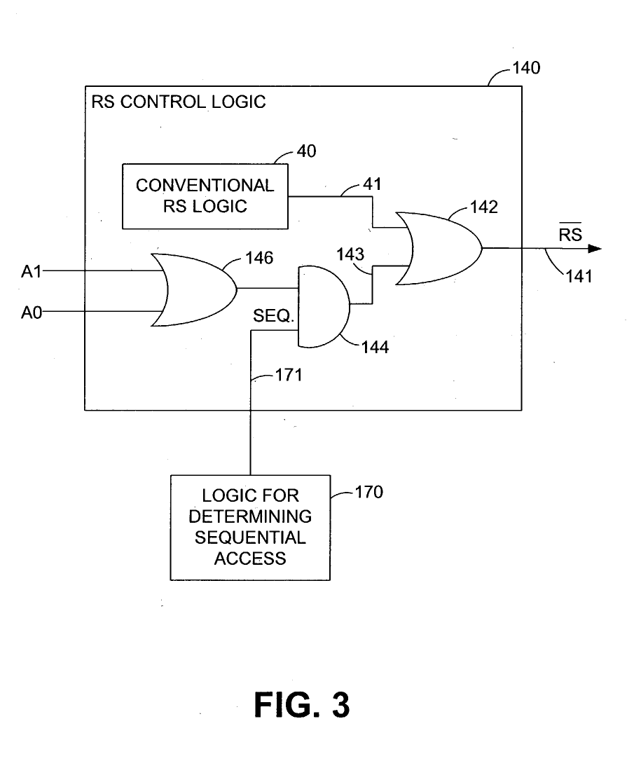

Reference is made to FIG. 3, which is a block diagram illustrating one embodiment of a potential implementation for the read strobe control logic 140. For simplicity in illustration, a component of this control logic is the logic 40 (of FIG. 1) that may be used for generating the read strobe signal in conventional cache memories. Assuming, in the context of the particular illustrated embodiment, that the read strobe 141 is an active low signal, then an OR gate 142 may be utilized to gate an inhibit signal 143 with the read strobe 41 generated by conventional read strobe logic 40. Thus, when the inhibit signal 143 is a logic 1, then the read strobe signal 141 is a logic 1, thereby inhibiting the strobing of the data memory 112. The remainder of the logic for generating the read strobe signal 141 operates to inhibit the read strobe if the data that is sought already resides in the latch. This determination may be made by recognizing that: (1) the data sought is sequentially located with respect to the previously-retrieved data; and (2) the data currently sought is not in the first location of the latch 113.

Logic 170 may be provided for indicating whether the currently-requested data is sequentially located with respect to the previously-retrieved data. If the cache memory is designed as a part of a processor circuit (e.g., onboard), then other signals or circuitry within the processor (if designed appropriately) may generate this signal 171 automatically. For example, this signal 171 may be readily generated from logic associated with the program counter, for an instruction cache. Alternatively, logic may be provided within the execution portion of a processor pipeline for generating the signal 171. Alternatively, the logic 170 may be designed as part of the cache itself. In such an embodiment, the logic may simply compare the tag held in the latch 15, from a previous data access, with the tag currently carried on the address bus 20 in connection with the identification of the data currently requested. The circuitry for performing such a comparison need not be described herein, as its design or development will be readily appreciated by persons skilled in the art.

If signal 171 indicates that the data access is sequential, for the embodiment of FIGS. 2 and 3, it must then ensure that the currently-requested data would not be the first data word of the latch 113. This determination can be readily made by ensuring that the two least significant address bits (e.g., A1 and A0) are not both logic zero. Therefore, in one implementation, an OR gate 146 may compare the two least significant address bits (A1 and A0). If either or both of these address bits is a logic one, then output of OR gate 146 is a logic one. This value may be compared by AND gate 144 with the signal 171, which indicates whether the currently-requested data is sequentially located with respect to the previously-retrieved data. If signal 171 is a logic one, and the output from OR gate 146 is a logic one, then the read strobe 141 will be inhibited. On the other hand, if the signal carried on line 171 is a logic zero (indicating the currently-requested data is not sequential), or if the currently-requested data resides in the first location of the latch 113, then the read strobe signal 141 will simply be the read strobe 41 output from the conventional read strobe logic 40.

To further illustrate, consider a data memory 112 having an eight word cache line, with an output latch 113 designed to hold four words read from the data memory 112. If the first data word requested corresponds to the first data word on a cache line, then (after filling the cache line from system memory) the read strobe control logic 140 does not inhibit the conventional read strobe signal (since the two least significant bits of the requested data would be logic zero, regardless of whether the requested data was sequential or not), so the first four words of the cache line would be retrieved into the latch 113. The multiplexer 160 would be controlled to direct the first word to the output 38. If the following request for data was for the second data word on that same cache line, then the logic 170 indicates that the request is a sequential access, and the value of the least significant address bits is one. Therefore, the logic 140 operates to inhibit the read strobe 141. This prevents the data memory 112 from consuming the power required to access and retrieve data therein, thereby reducing the power that would otherwise be consumed by the data memory in retrieving the data. The multiplexer 160 could then be selected to deliver the second data word to the output 38.

To further illustrate with a slightly different example, if the first request for data was for a data word residing in the second location of a cache line (assuming the cache retrieves the data from system memory from even cache line boundaries), the read strobe signal 141 would not be inhibited. Although the least significant address bits would not indicate that the data resides in the first location of the latch 113, the logic 170 for generating the sequential access signal 171 wold be at a logic zero, thereby indicating that the data access is not sequentially located with respect to the previous data retrieved.

It should be appreciated that the embodiment of FIG. 3, which uses the two least significant bits of the address bus (A1 and A0) is designed for a latch 113 that holds four data words. It can, however, be readily expanded for latches of different sizes. For example, if the latch held only two data words, then only address line A0 would be needed, and OR gate 146 would not be required (address line A0 would be input directly to AND gate 144). Likewise, if the latch held 8 data words, then address lines A2, A1, and A0 would be utilized (all input to a three-input OR gate).

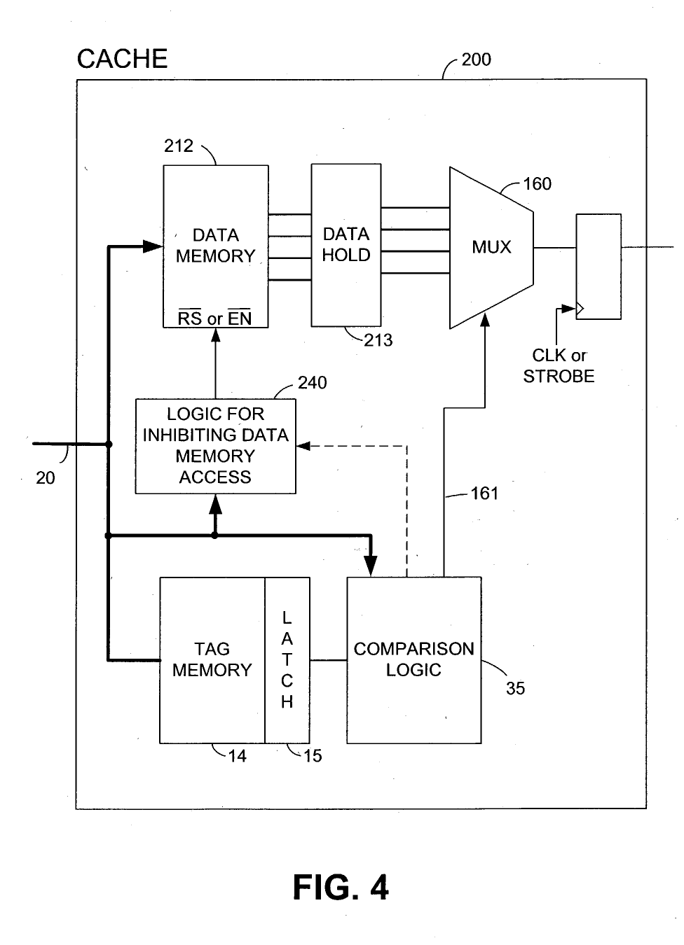

Reference is now made to FIG. 4, which is similar to FIG. 2, but illustrates a slightly different embodiment of the present invention. It should be appreciated from the foregoing discussion that a key aspect of the present invention is the recognition that the data currently requested resides in a latch, or other circuit component within the cache, so that the data need not be separately and independently retrieved from the data memory portion of the cache. Due to the largely sequential nature of data accesses, this results in a significant power savings by inhibiting needless data reads of the data memory. In the embodiment illustrated in FIG. 4, the data memory 212 may be designed such that a latch is not an integral part of the data memory. Accordingly, a data hold component 213 is illustrated as being coupled to the output of the data memory 212. The data hold component, in one embodiment, may be a latch. However, consistent with the scope and spirit of the present invention, the data hold component 213 may be any of a variety of other components as well.

FIG. 4 also illustrates logic 240 for inhibiting data memory accesses. The logic 240 may be implemented identically to the logic 140 of FIG. 2. In other embodiments, however, the logic 240 may take on a different form. As one example, the logic 140 illustrated in connection with FIG. 2 was used in combination with conventional read strobe generation logic. It should be appreciated that the present invention is not limited to embodiments that inhibit a read strobe signal, but is readily applicable to embodiments that may otherwise inhibit the active operation of the data memory 212. In one embodiment, an enable signal may be provided in connection with a data memory element, separate and distinct from the read strobe input. The logic 240 of the embodiment of FIG. 4 may generate such a signal and direct it to an enable input or other input of the data memory 212 for inhibiting its normal operation. In such an embodiment, conventional read strobe generation circuitry (not illustrated in FIG. 4) may be coupled to the read strobe input of the data memory 212.

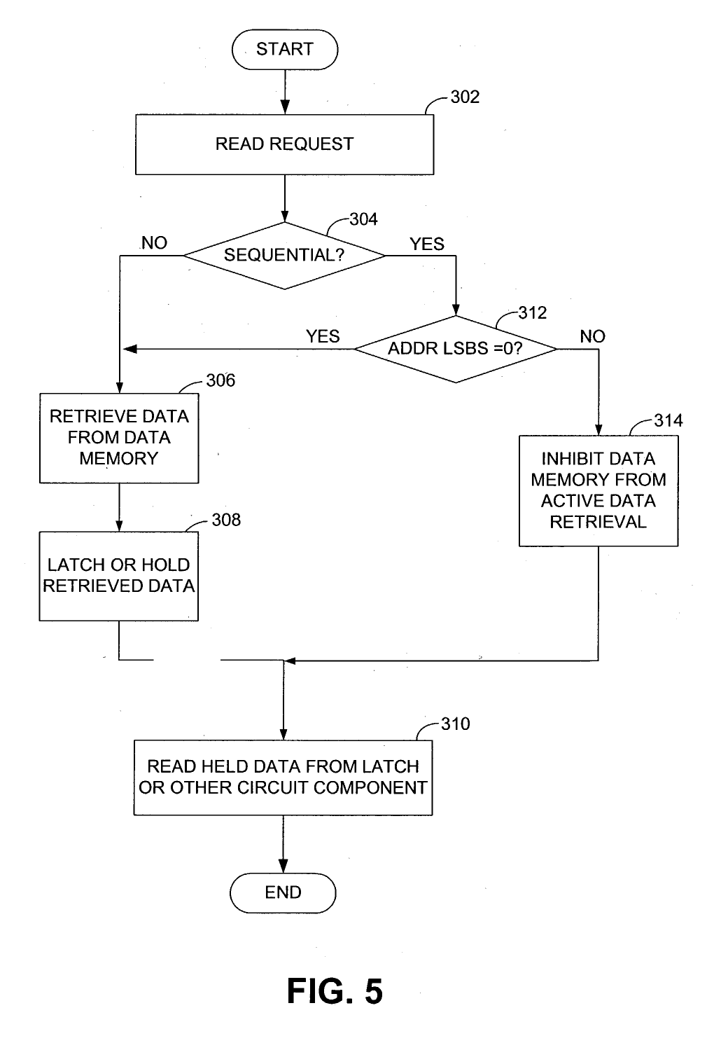

Having described certain architectural embodiments of the invention, reference is now made to FIG. 5, which is a flowchart illustrating a top-level functional operation of one embodiment of the present invention. In a first step, a read request is made (step 302), or data is otherwise requested from the data memory portion of the cache. The embodiment then determines whether the requested data is sequentially located with respect to the previously-retrieved data (step 304). If the data is not sequentially located, then data is retrieved from the data memory portion of the cache (step 306) and latched into a latch component coupled to the output of the data memory (step 308), as in conventional cache operation. Thereafter, data may be read from the latch (step 310) and output from the cache. If, however, step 304 determines that the requested data is sequentially located with respect to the previously-retrieved data, then the method determines whether the least significant bits of the address line are all logic zero (step 312). If so, it is determined that the data will reside in the first location of the latch, and the method proceeds to step 306. If, however, the least significant address bits are not equal to zero, then the method operates to inhibit the data memory from performing an active data retrieval (step 314), and reads the data directly from the latch or other component capable of holding data (step 310).

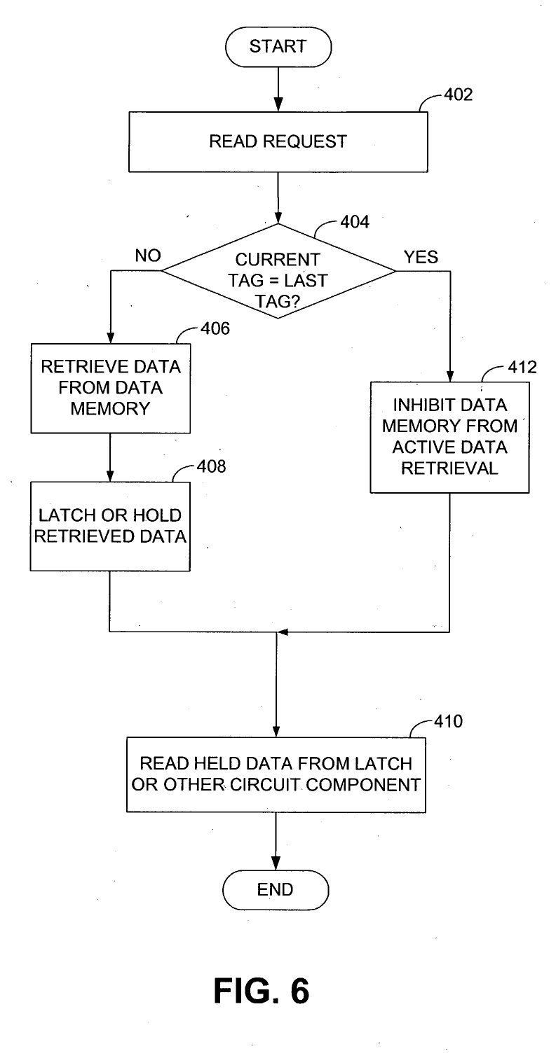

Reference is now made to FIG. 6, which is a flowchart illustrating the top-level functional operation of another embodiment of the invention. Like FIG. 5, the method of FIG. 6 begins when a read request is made to the data memory (step 402). Thereafter, the method determines whether the current tag is the same as the previous tag. If not, then data must be read from a different cache line, and therefore cannot reside in the latch. Therefore, if step 404 resolves to no, then data is retrieved from the data memory (step 406) and latched (step 408) as described in connection with FIG. 5. Thereafter, data may be read from the latch (step 410). If, the tag of the currently-requested data is the same as the tag from the previously-retrieved data, then it is determined that the currently-requested data resides in the latch. For this determination to hold consistently true, it will be appreciated that the latch of the embodiment of FIG. 6 is of equal size to the cache line of the data memory area. Thereafter, if the determination of step 404 resolves to yes, then the method inhibits the data memory from active data retrieval (step 412) and the data may be read from the latch or other component capable of holding data (step 410).

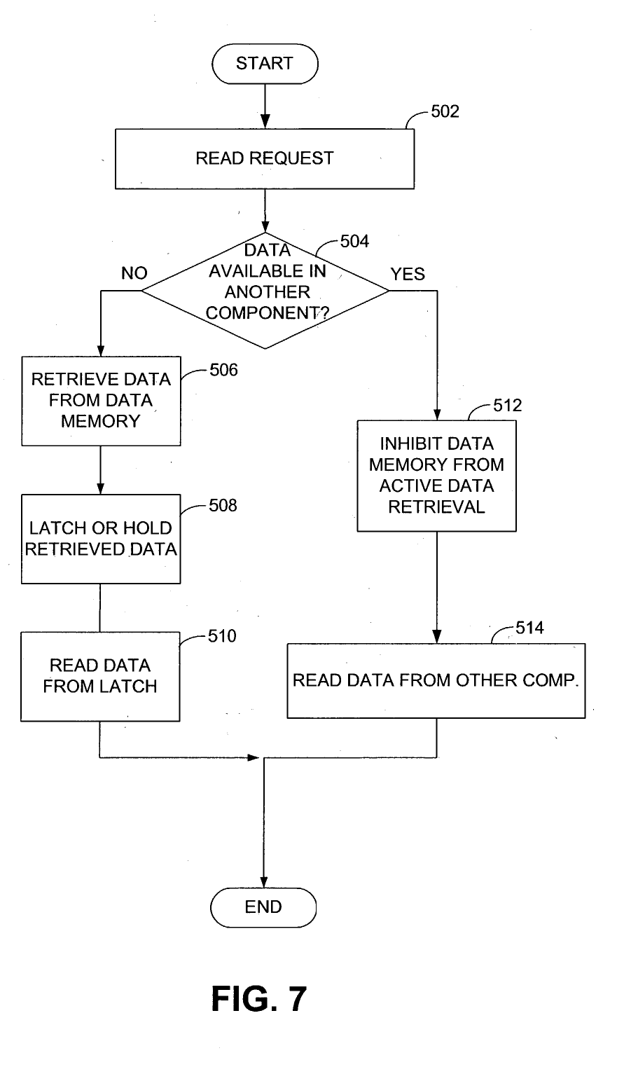

Reference is now made to FIG. 7, which is a flowchart illustrating the top-level functional operation of yet another embodiment of the invention. Like the embodiments of FIGS. 5 and 6, the method of FIG. 7 begins with a read request for data within the data memory of the cache (step 502). The method of FIG. 7 is suitable for cache architectures different than those illustrated in FIGS. 2 and 4. Specifically, it is recognized that certain cache architectures may be provided that do not have a latch or other holding component coupled to the output of the data memory. However, certain architectures may nevertheless retrieve data from the data memory and hold that data in yet another circuit component, until a later cache line is read. In the embodiment of FIG. 7, a determination is made as to whether the requested data is currently available in another component within the cache (step 504). By “another” component, step 504 is referring to a component other than the data memory. Therefore, the “another” component could be a latch (as in FIG. 2), a data hold circuit component (as in FIG. 4), or some other component within the cache. If the data is not readily available in another component, then it may be retrieved from the data memory (step 506) and latched (or held) by another circuit component (step 508), as described above in connection with FIGS. 5 and 6. Thereafter, the held data may be read (step 510). If, however, step 504 determines that the currently-requested data is available in another component within the cache, then the data memory may be inhibited from normal operation (step 512) and the currently-requested data may be directly read from the “another” component from which it is currently available (step 514).

It should be appreciated from the foregoing that a variety of alternative embodiments, applicable to a variety of cache architectures, a readily implementable, consistent with the scope and spirit of the invention. The embodiments and described herein have been particularly chosen for simplicity in illustration of certain aspects of the present invention.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A cache comprising:
a data memory;
latching logic coupled to an output of the data memory and configured to latch data output from the data memory;
determining logic responsive to a request for data, the determining logic configured to determine whether requested data currently resides in the latching logic; and
inhibit logic configured to inhibit active operation of the data memory, in response to the determining logic, if it is determined that the requested data currently resides in the latching logic.

2. The cache as defined in claim 1, wherein the determining logic is configured to determine whether the requested data is defined be an address that is sequential to an address of data requested in an immediately-preceding data request.

3. The cache as defined in claim 1, wherein the determining logic is configured to receive a signal output from a processor, the signal indicating whether the requested data is addressed at an address that is sequential to an address of data requested in an immediately-preceding data request.

4. The cache as defined in claim 2, wherein the determining logic includes comparison logic for comparing an address tag of the requested data with an address tag of an immediately-preceding data request.

5. The cache as defined in claim 1, wherein the inhibit logic comprises logic configured to inhibit a read strobe input of the data memory.

6. The cache as defined in claim 1, wherein the inhibit logic comprises logic configured to inhibit an enable input of the data memory.

7. The cache as defined in claim 1, wherein the inhibit logic is configured to receive a signal output from the determining logic, the inhibit logic generating an output that is based on a value of the signal output from the determining logic.

8. The cache as defined in claim 1, wherein the inhibit logic is configured to evaluate one or more lower address bits of the requested data and determine whether the requested data is currently available for retrieval from the latching logic based on a size of the latching logic and an address implicated by the one or more lower address bits.

9. A cache comprising:
a data memory; and
logic configured to inhibit the data memory from retrieving requested data, if the requested data was previously read from the data memory and is currently available for retrieval from another circuit component with the cache.

10. The cache as defined in claim 9, wherein the another circuit component is a latch that is coupled to an output of the data memory.

11. The cache as defined in claim 9, wherein logic configured to inhibit is configured to generate an output that inhibits a read strobe of the data memory.

12. The cache as defined in claim 9, wherein the logic configured to inhibit is configured to evaluate one or more lower address bits of the requested data and determine whether the requested data is currently available for retrieval from the another component based on a size of the another component and an address implicated by the one or more lower address bits.

13. The cache as defined in claim 10, further including determining logic responsive to a request for data, the determining logic configured to determine whether requested data currently resides in the latch.

14. The cache as defined in claim 13, wherein the logic configured to inhibit operates in response to the determining logic.

15. A cache memory comprising:
a data memory;
logic configured to retrieve, in response to a first request for data, the requested data and at least one additional word of data;
logic configured to hold the retrieved data in a circuit component; and
logic capable of inhibiting active operation of the data memory and to retrieve subsequently-requested data from the circuit component.

16. The cache as defined in claim 15, wherein the logic capable of inhibiting is configured to inhibit a read strobe of the data memory if the requested data is currently-available to be retrieved from the circuit component.

17. The cache as defined in claim 15, wherein the circuit component is a latch that is coupled to an output of the data memory.

18. The cache as defined in claim 15, further including determining logic configured to determine if the subsequently-requested data currently resides in the circuit component.

19. The cache as defined in claim 15, wherein the logic capable of inhibiting is configured to inhibit the active operation of the data memory and to retrieve the subsequently-requested data from the circuit component in response to the determining logic determining that the subsequently-requested data currently resides in the circuit component.

20. In a cache memory having a data memory for storing data and an output latch for latching data retrieved from the data memory, a method for reading requested data from the cache memory comprising:
determining whether the requested data currently resides in the latch from a previous data read;
inhibiting the data memory from retrieving data, in response to a determination that the requested data currently resides in the latch;
retrieving data from the data memory into the latch, in response to the determination that the requested data does not currently reside in the latch; and
reading data from the latch.

21. The method as defined in claim 20, wherein the step of determining comprises determining whether the requested data is addressed sequential to data requested in an immediately-preceding request

22. The method as defined in claim 21, wherein the step of determining further comprises determining that the requested data does not reside in a first boundary location of the latch.

23. The method as defined in claim 22, wherein the step of determining that the requested data does not reside in a first boundary location of the latch further comprises:
ensuring that the least significant address bit of the data memory is not equal to zero, if the latch holds two words of data; and
ensuring that the two least significant address bits of the data memory are not equal to zero, if the latch holds four words of data.

24. The method as defined in claim 20, wherein the step of inhibiting the data memory from retrieving data more specifically comprises gating a read strobe input signal to the data memory in response to the determining whether the requested data is already held in the latch from a previous data read.

25. A method for reading requested data from a cache memory comprising:
in response to a first request for data, retrieving from a data memory more words of data than requested by the first request;
temporarily holding the retrieved data in a circuit component;
in response to a second, subsequent request for data, inhibiting active operation of the data memory and retrieving the requested data from the circuit component.

26. The method as defined in claim 25, wherein further including the step of determining whether the data requested by the second, subsequent request for data currently resides in the circuit component.

27. The method as defined in claim 25, wherein the step of temporarily holding the retrieved data in a circuit component more specifically includes latching the retrieved data in a latch component.

28. The method as defined in claim 25, wherein the step of retrieving from a data memory more specifically includes retrieving two words of data, when the first request requests one word of data.

29. The method as defined in claim 25, wherein the step of retrieving from a data memory more specifically includes retrieving four words of data, when the first request requests one word of data.
